(19) United States
(12) Patent Application Publication
(10) Pub. No.: US 2025/0124539 A1
(43) Pub. Date: Apr. 17, 2025

(54) Systems and Methods for Progressive Rendering of Refinement Tiles in Images

(71) Applicant: Google LLC, Mountain View, CA (US)

(72) Inventors: Jyrki Alakuijala, Wollerau, Schwyz (CH); Moritz Joachim Firsching, Rheinfelden (DE)

(21) Appl. No.: 18/683,847

(22) PCT Filed: Aug. 31, 2021
(86) PCT No.: PCT/US2021/048423

§ 371 Date: Feb. 15, 2024

(51) Int. Cl. G06T 3/40; G06F 3/01; G06T 5/70; G06V 10/25; G06V 10/46; G06V 10/70; H04N 19/136; H04N 19/162; H04N 19/167; H04N 23/61; H04N 23/63

(52) U.S. Cl. CPC G06T 3/40; G06T 5/70; G06V 10/462; H04N 19/136; H04N 19/162; H04N 19/167; H04N 23/61; H04N 23/632; G06F 3/013; G06T 2200/24; G06V 10/25; G06V 10/70

(57) ABSTRACT

A computer-implemented method is provided. The method includes receiving, via a computing device, a plurality of bytes of an encoded image, wherein the encoded image comprises a salient portion. The method further includes determining a bounding region for the encoded image, wherein the bounding region is indicative of a location of the salient portion in the encoded image. The method also includes progressively rendering a decoded version of the encoded image, wherein the progressively rendering comprises rendering a high resolution version of the bounding region, and a low resolution version of a portion outside the bounding region.

### BACKGROUND

Many modern computing devices, including mobile phones, personal computers, and tablets, display images. The images may be received in an encoded format over a network, or may be captured by image capture devices of the computing device. The images may include salient features such as images that include people, animals, landscapes, and/or objects.

Images displayed as part of a webpage are sequentially rendered from a top portion of the image to a bottom portion of the image until the image is completely rendered. This may lead to undue delays in the display of the salient features of the image.

### SUMMARY

In one aspect, a computing device may be configured to progressively render an image to prioritize display of one or more salient features in an image.

In one aspect, a computer-implemented method is provided. The method includes receiving, via a computing device, a plurality of bytes of an encoded image, wherein the encoded image comprises a salient portion. The method further includes determining a bounding region for the encoded image, wherein the bounding region is indicative of a location of the salient portion in the encoded image. The method also includes progressively rendering a decoded version of the encoded image, wherein the progressively rendering comprises rendering a high resolution version of the bounding region, and a low resolution version of a portion outside the bounding region.

In another aspect, a computing device is provided. The computing device includes one or more processors and data storage. The data storage has stored thereon computer-executable instructions that, when executed by one or more processors, cause the computing device to carry out functions. The functions include: receiving a plurality of bytes of an encoded image, wherein the encoded image comprises a salient portion; determining a bounding region for the encoded image, wherein the bounding region is indicative of a location of the salient portion in the encoded image; and progressively rendering a decoded version of the encoded image, wherein the progressively rendering comprises rendering a high resolution version of the bounding region, and a low resolution version of a portion outside the bounding region.

In another aspect, an article of manufacture is provided. The article of manufacture includes one or more computer readable media having computer-readable instructions stored thereon that, when executed by one or more processors of a computing device, cause the computing device to carry out functions. The functions include: receiving a plurality of bytes of an encoded image, wherein the encoded image comprises a salient portion; determining a bounding region for the encoded image, wherein the bounding region is indicative of a location of the salient portion in the encoded image; and progressively rendering a decoded version of the encoded image, wherein the progressively rendering comprises rendering a high resolution version of the bounding region, and a low resolution version of a portion outside the bounding region.

In another aspect, a system is provided. The system includes means for receiving a plurality of bytes of an encoded image, wherein the encoded image comprises a salient portion; means for determining a bounding region for the encoded image, wherein the bounding region is indicative of a location of the salient portion in the encoded image; and means for progressively rendering a decoded version of the encoded image, wherein the progressively rendering comprises rendering a high resolution version of the bounding region, and a low resolution version of a portion outside the bounding region.

The foregoing summary is illustrative only and is not intended to be in any way limiting. In addition to the illustrative aspects, embodiments, and features described above, further aspects, embodiments, and features will become apparent by reference to the figures and the following detailed description and the accompanying drawings.

### BRIEF DESCRIPTION OF THE FIGURES

FIG. 1 illustrates comparative images based on different rendering algorithms, in accordance with example embodiments.

FIG. 2 illustrates a saliency map, in accordance with example embodiments.

FIG. 3 illustrates an image with an ordering, in accordance with example embodiments.

FIG. 4 illustrates example images with respective saliency maps, in accordance with example embodiments.

FIG. 5 illustrates additional example images with respective saliency maps, in accordance with example embodiments.

FIG. 6 is a diagram illustrating training and inference phases of a machine learning model, in accordance with example embodiments.

FIG. 7 depicts a distributed computing architecture, in accordance with example embodiments.

FIG. 8 is a block diagram of a computing device, in accordance with example embodiments.

FIG. 9 depicts a network of computing clusters arranged as a cloud-based server system, in accordance with example embodiments.

FIG. 10 is a flowchart of a method, in accordance with example embodiments.

### DETAILED DESCRIPTION

This application relates to progressive rendering of an image. Progressive image decoding is a process where the image decoding is refined during the transmission. For example, a blurry image is rendered first and it gets sharper when more data is transmitted. Generally, about 25% of images are compressed as progressive JPEGs. Progressive JPEG is a protocol that is often used to transmit images. In addition, JPEG XL supports progressive rendering. Other image formats such as AVIF may also support progressive rendering.

Generally, although resources such as a computer, cable, power, and so forth are important in information processing systems, time, and cognitive resources of a human being consuming a product of the processing systems is also valuable. For example, while viewing a webpage, a significant amount of time may be spent by a person waiting for an image to upload. It is therefore desirable to reduce such waiting times. Conventional techniques may display a low resolution image, and a high resolution image may be subsequently rendered from top to bottom. Such a rendering may involve multiple passes of image refinement.

Images may include a focal point, such as, for example, a nose and eyes of a portrait. When a user views an image, they may not initially view the entire image, but may instead focus on portions that are interesting, or “salient,” parts of the image. Generally, portions of the image that include the focal point may not appear at the top of the image. Accordingly, when rendering an image using conventional techniques, the focal point may generally not be rendered first, as the rendering is performed sequentially from the top of the image to the bottom of the image. Accordingly, when the image is rendered from the top to the bottom, a pre-attentive mechanism of a viewer may be unnecessarily engaged, and attention may be directed to areas of the image that do not include the focal point. For example, as a blurry image becomes sharper during a rendering process, such sharpening may be a pre-attention activity that can be distracting for a viewer of the image. As such activities increase, so does consumption of a user's cognitive resources. Thus, a user's cognitive facilities may be burdened and a user's time may be consumed in viewing portions of an image that may not be relevant. Generally, in traditional approaches, users have become conditioned to such sequential rendering.

Accordingly, in some aspects, an image may be progressively rendered so that a portion that includes a focal point (or salient features) of the image may be rendered first. This may reduce an amount of visual action in rendering the image, thereby reducing a stress on a user's cognitive resources, and redirecting a user's attention to the focal point of the image. Although rendering a single image may lead to savings of a fraction of a second, a cumulative time saved over all images viewed may be significant. Time spent by a user on relevant portions of a webpage may be important to the efficiency of displaying a webpage, and such time spent may contribute significantly to a utility of a webpage, based at least in part on user experience metrics. Therefore enhancing web experiences for users and reducing computational resources are of high importance. Accordingly, delivering images quickly is an important aspect of the web experience, and progressive images can prioritize rendering of the salient features.

One advantage of such progressive rendering is that the salient features are rendered first. Consequently, even if a user does not view the rendered image in its entirety (e.g., stops loading the website), the user would have likely viewed the salient features.

As the number of bits increases (e.g., 4K to 8K), image rendering may lead to more buffering, more cost, more memory allocation, more network resources, and so forth. Thus, rendering salient features first may make the transition to a larger number of pixels more affordable.

### Progressive Rendering

The herein-described techniques can improve image rendering by applying more desirable and/or selectable rendering algorithms, thereby enhancing an actual and/or perceived quality of an image rendering. Enhancing the actual and/or perceived quality of images can provide emotional benefits to viewers of a webpage. These techniques are flexible, and so can apply to a wide variety of images of human faces and other objects.

Transmission of images may be performed in accordance with certain formats, such as those established by the Joint Photographic Experts Group (JPEG), Graphics Interchange Format (GIF), Exchangeable Image File Format (EIFF), Tagged Image File Format (TIFF), Bitmap (BMP) File Format, Portable Network Graphics (PNG), Portable Pixmap File Format (PPM), the Portable Graymap File Format (PGM), the Portable Bitmap File Format (PBM), WebP format, and so forth.

JPEG XL, projected to be a long-term extension of the JPEG format, has two primary ways of supporting progressive rendering. For example, a DC image may be received first, and then an entire image level may pass. The term “DC image” generally refers to a DC-only scan, where an average color of each 8×8 block is from a DC-component in the discrete cosine transform (DCT), which is a basis of JPEG image compression. Another way of supporting progressive rendering may be to deliver one or more of the image passes as 256×256 refinement tiles. The refinement tiles may be in any order chosen at the time of encoding the image. When complex visual update patterns are used, the updates may activate ‘pre-attentive processing’ of a visual system of a viewer, and the updates in the image may capture the focus of the viewer.

Some image formats are implemented in a way that may not allow progressive image loading. For example, all of the bytes of the image may have to be received before rendering can commence. Another type of image loading is sequential image loading. For such image rendering techniques, the data may be organized in a way such that pixels come in a particular order, typically in rows and from top to bottom. Formats with this kind of image loading include PNG, WebP, and JPEG. The JPEG format may generally allow sophisticated forms of progressive image encodings. For example, image data may be organized so that it is rendered in multiple scans, with each scan showing more detail than a previous one.

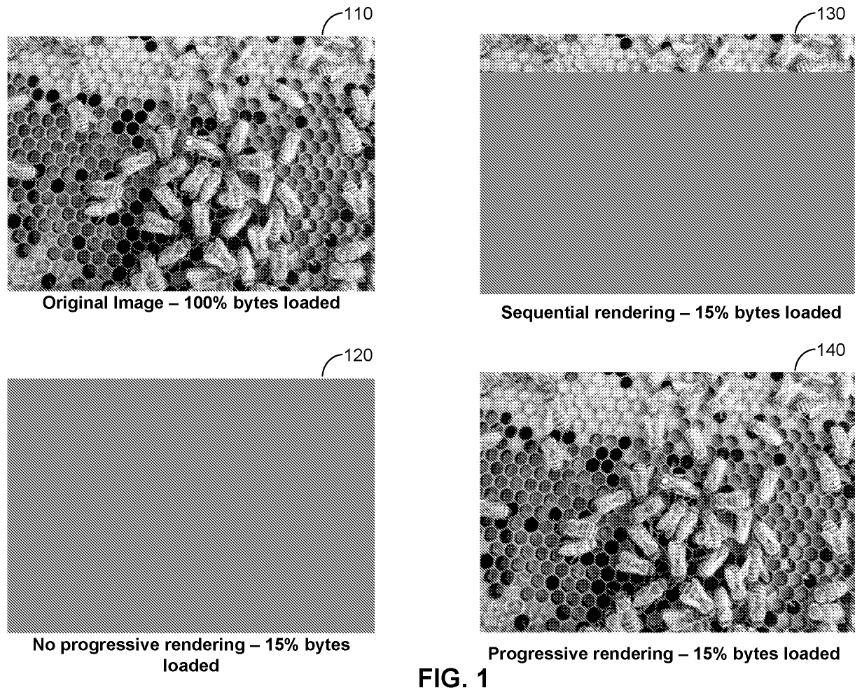

FIG. 1 illustrates comparative images based on different rendering algorithms, in accordance with example embodiments. Image 110 is an example original image where 100% of the bytes have been loaded and rendered. Image 120 is an example of a rendering technique where progressive rendering is not used. As illustrated, with 15% of the bytes in an image loaded, a small amount of information is available for the image. For example, an average color of 8×8 blocks may be shown. This scan is called a DC-only scan, because the average color of each 8×8 block is called a DC-component in the discrete cosine transform, which is the basis of JPEG image compression.

Instead of displaying an image that consists of 8×8 blocks, JPEG rendering in web browsers may render a preview with some smoothing, to provide a less distracting experience. While the quality (and therefore byte-sizes) of the individual scans in a progressive JPEG image can be controlled, the order within a scan is still top to bottom, like in a sequential JPEG. Image 130 is an example image rendered using a conventional sequential rendering technique. As illustrated, with 15% of the bytes rendered, a top portion of the image is rendered.

Image 140 is an example of an image rendered using a progressive rendering techniques as disclosed herein. For example, even when approximately 15% of the data for an image is loaded, a significant amount of image content has been rendered, as indicated by comparison to image 110 where 100% of the image has been rendered.

Some image formats, such as JPEG XL, may enable sending of data necessary to display details of the salient features first, followed by details of less salient features. For example, in a portrait, bytes representing a face may be transmitted first, followed by bytes representing an out-of-focus background.

In some embodiments, a computing device can receive a plurality of bytes of an encoded image, wherein the encoded image comprises a salient portion. For example, an encoded image can be received with saliency features identified. In some embodiments, the plurality of bytes may include a stream of bytes, and bytes in the stream of bytes may be sequentially ordered so that the salient portion of the image is received first. For example, the encoded image may be encoded in a JPEG-XL format. Thus, the image may be encoded with a preferred ordering of portions of the image. In some embodiments, an image may be received without an identified salient portion. However, a salient portion may be identified at the time the image is received. In some embodiments, the salient portion may be identified by applying a trained machine learning model. For example, an object detection model can be trained to identify one or more salient portions in the image. Subsequently, an encoder can convert the received image into a format that includes information about the identified one or more salient portions.

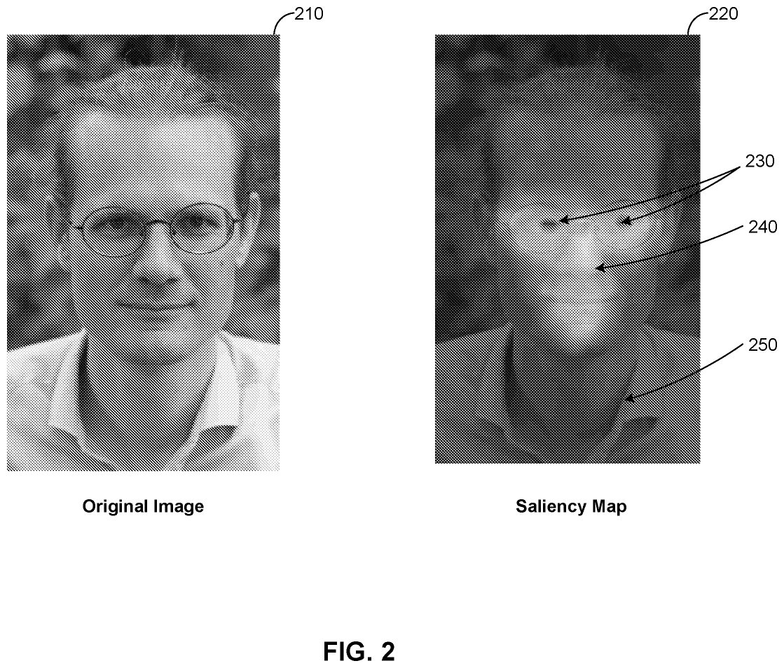

FIG. 2 illustrates a saliency map, in accordance with example embodiments. Image 210 is an example portrait, and image 220 represents a saliency map of image 210. For example, image 210 illustrates a heat map of image 210, indicating one or more salient portions in image 210, such as, for example, the eyes, the nose, and the mouth. In some embodiments, the saliency map may be an image comprising different regions, with a first region representing a salient portion with a high order of saliency, a second region representing a salient portion with a medium order of saliency, and a third region representing a salient portion with a low order of saliency. For example, the saliency map may be an RGB image, with a red color, R. representing a salient portion with a high order of saliency, such as portions 230. Also, for example, a green color, G, may represent a salient portion with a medium order of saliency, such as portion 240, and a blue color, B, may represent a salient portion with a low order of saliency, such as portion 250.

In some embodiments, the computing device can determine a bounding region for the encoded image, wherein the bounding region is indicative of a location of the salient portion in the encoded image. In some embodiments, the bounding region may be a region that includes an identified salient portion. For example, when the image depicts a bird perched on a tree, the bounding region may be a region that includes the portion of the image with the bird. In some embodiments, when more than one saliency feature is detected, the bounding region may be positioned in such a manner so as to maximize rendering of the saliency features quickly. For example, when the saliency features are the two eyes of a portrait, the bounding region may be positioned between the two eyes. As another example, for two or more saliency features, respective bounding regions for each of the two or more saliency features may be determined, and these bounding regions may be rendered simultaneously. For example, the saliency features may be far apart, and rendering them simultaneously may produce an artistic visual effect.

In some embodiments, different options for bounding regions may be generated. and an optimal bounding region may be selected to enable rendering of the salient features in an efficient manner. In some embodiments, the bounding regions may be refinement tiles shaped as squares, rectangles, hexagons, and so forth. Generally, any shape that can tile a planar region may be used as a refinement tile. For example, squares of different sizes that are expanding out may be used. Also, for example, the bounding region may be a square and the next set of regions may be rectangles, and so forth. However, a choice of a bounding region may have an impact on a visual perception of flickering. For example, it may be desirable to make the rendering process faster, generate fewer visual attentive clues to induce less stress on a viewer's cognitive resources, and to provide a uniform user experience. Accordingly, in some embodiments, perceived optical flicker may be reduced by decreasing a length of a boundary of a bounding region, to reduce a difference between a high resolution portion of the image and a low resolution portion of the image. In some embodiments, using squares as bounding regions can allow viewers to get accustomed to the shapes and/or rendering process.

In one approach, an image may be tiled with refinement tiles, such as, for example, squares of the same size. For example, the image may be divided into refinement tiles (e.g., size 256×256 square tiles). In some embodiments, an encoder may divide the image using such refinement tiles, and once a salient portion is determined, the encoder may sequentially order the refinement tiles, with “1” assigned to a bounding region, and expanding outwards concentrically with refinement tiles numbered as “2,” “3”, and so forth. Generally, the refinement tiles may be ordered based on saliency. Such an ordering assigns a natural preference to regions where a viewer's attention may be directed while viewing the image.

As described herein, the computing device may receive the encoded image that includes the refinement tiles and the ordering of the refinement tiles. Accordingly, at the time of decoding, the computing device can begin the decoding and rendering process at the refinement tile numbered “1,” and continue progressively to the other tiles based on the sequential numbering.

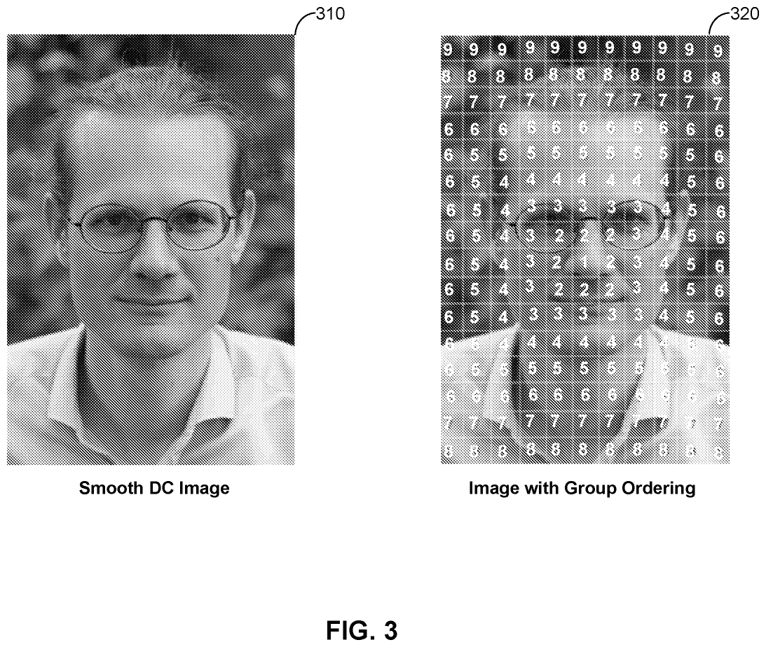

FIG. 3 illustrates an image with an ordering, in accordance with example embodiments. Image 310 is an example smooth image. For example, image 310 may be a smooth DC image, such as an 8×8 downsampled image. As indicated with reference to image 220 of FIG. 2, a heat map may be generated that indicates one or more salient portions of the image. Based on the one or more salient portions, the image may be tiled with refinement tiles (e.g., size 256×256 square tiles).

In general, progressive JPEG-XL provides an 8×8 downsampled image available (similar to a DC-only scan in a progressive JPEG). A decoder can display that downsampled image with an upsampling, which may be perceived as a smoothed version of the image. While the JPEG-XL format allows for a flexible ordering of the refinement tiles, in some embodiments, an encoder may choose an initial refinement tile or a group of refinement tiles as a bounding region, and then grow concentric refinement tiles around that initial refinement tile or group of refinement tiles. Such a process may result in reduced visual distraction for a viewer of the image.

In some embodiments, the encoded image may be partitioned into a plurality of sequentially ordered regions, wherein a lower position in the sequential ordering may be indicative of the salient portion of the image. For example, as indicated in image 320, the refinement squares may be sequentially numbered starting at “1,” where “1” is indicative of a bounding region. The eight refinement squares adjacent to the square numbered “1” may be assigned a number “2.” Proceeding concentrically outward, the sixteen squares adjacent to the squares numbered “2” may be assigned a number “3,” and so forth. A comparison with image 220 indicates that the salient features may be bounded by a collection of refinement squares numbered “1,” “2,” and “3.” Accordingly, a square tile numbered “1” may be selected as an optimal initial bounding region to render the one or more salient features in an efficient manner.

In some embodiments, the computing device can progressively render a decoded version of the encoded image. The progressively rendering may include rendering a high resolution version of the bounding region, and a low resolution version of a portion outside the bounding region. For example, referring to image 320, decoding may be performed in the order in which the bytes are received. For example, the square tile numbered “1” may be decoded first, followed by the eight square tiles numbered “2,” followed by the sixteen square tiles numbered “3,” and so forth. Also, for example, the rendering process may be performed in a similar manner, starting with a high resolution rendering of square tile numbered “1,” or a combination of square tiles numbered “1” and “2,” or a combination of square tiles numbered “1,” “2”, and “3”. Accordingly, the one or more salient portions may be rendered first.

In some embodiments, the salient portion may be a first salient portion, and the image may include a second salient portion, and the determining of the bounding region may involve determining the bounding region so as to prioritize rendering of the first salient portion and the second salient portion. For example, when the image is a portrait, there may be at least two salient portions that correspond to the location of the eyes. Accordingly, in some embodiments, an initial refinement tile may be selected to be located between the two eyes. In some embodiments, the initial refinement tile or group of s refinement tiles may be as illustrated in image 320, including, for example, a square tile numbered “1”, or a combination of square tiles numbered “1” and “2”, or a combination of square tiles numbered “1”, “2”, and “3”. Generally, for a heat map, the computing device may determine portions of the image that have a higher indication of a presence of salient features (e.g., red portions in an RGB map), and a bounding region may be determined to be a region that is proximate to such portions of the image. For example, a centroid of these portions may be determined, and a bounding region may be selected to be positioned at or about the centroid. In some embodiments, a first salient portion may be associated with a first bounding region and a second salient portion may be associated with a second bounding region, and the rendering may proceed with both of these bounding regions simultaneously. For example, refinement tiles associated with the two bounding regions may be numbered “1,” with surrounding refinement tiles numbered “2” and so forth. Accordingly, rendering may allow two or more refinement tiles to grow outward as they are simultaneously refined. In some embodiments, this may be useful for images having two independent but equal saliency points. Also, for example, such a rendering may be used to perform an artistically visually appealing rendering of an image.

In some embodiments, the determining of the bounding region may include selecting, from a plurality of candidate bounding regions, a bounding region that prioritizes rendering of the salient portion, or a plurality of salient portions. For example, with reference to image 320), the initial bounding region may be the refinement tile numbered “1.” However, one or more refinement tiles in a vicinity of the eyes may be numbered “1.” As another example, a refinement tile close to the left eye may be numbered “1,” or a refinement tile close to the right eye may be numbered “1.” As another example, a refinement tile located between the two eyes may be numbered “1.” Upon selection of a refinement tile numbered “1,” adjacent refinement tiles may be numbered “2,” and so forth, in a concentric manner. In some embodiments, the computing device may select from among these various configurations to select a bounding region that prioritizes rendering of the salient portion, or a plurality of salient portions. In some embodiments, a statistical optimization model (e.g., a trained machine learning model) may be utilized to optimize selection of a bounding region that prioritizes rendering of the salient portion or a plurality of salient portions. For example, the statistical model may output rendered images based on different choices for bounding regions, and the outputs may be labeled (e.g., by a human being or a trained machine learning model) to identify an output that corresponds to minimal perceived flickering. A machine learning model may then be trained with such labeled training data.

In some embodiments, the method may involve determining a time to commence the progressively rendering of the decoded version of the encoded image. For example, as a stream of bytes corresponding to the encoded image is received, in one embodiment, the computing device may begin decoding contemporaneously with a receipt of the stream of bytes. In some embodiments, the computing device may wait until a certain number of bytes are received. In yet other embodiments, the stream of bytes may arrive in batches, and the rendering may be performed in batches as they are received. In some embodiments, an optimal time may be determined as to when to commence decoding and rendering an image, based on, for example, a minimal adverse visual impact (e.g., perceived flickering) on a viewer.

Although an encoding may include information about the salient portions, and/or an ordering of the bytes, the encoding might not include information about when a decoder may commence rendering of the image. In some embodiments, the decoder may determine a time when the rendering can commence. In some embodiments, the bounding region may be encoded by a sub-plurality of the plurality of bytes, and the determining of the time may include determining the time, by a decoder of the image, to be subsequent to receiving the sub-plurality of the plurality of bytes. For example, the computing device may wait for all the bytes corresponding to a bounding region to arrive before commencement of the rendering. In some embodiments, the determining of the time may be performed by an encoder of the image. For example, the encoder may identify one or more salient portions, determine one or more bounding regions, and/or determine a sequential numbering of the one or more bounding regions. Also, for example, the encoder may determine a time when a decoding may commence. Such information may be transmitted as part of the encoded image format. Accordingly, receiving of the encoded image may include receiving the time to commence the progressive rendering of the encoded image. Upon receipt of the encoded image, a decoder may decode information about the time to commence rendering.

In some embodiments, the rendering may be performed as the bytes are received. In some embodiments, the rendering may be performed when bytes corresponding to the entire refinement tile are received. Accordingly, a refinement tile that corresponds to a salient portion may be rendered in a timely manner but with minimal perceived flickering. Also, for example, in some embodiments, an entire image may be displayed after it is rendered to minimize perceptible flickering during a rendering process. For example, a user interface may be provided a selectable option that enables the user to indicate an amount of rendering to be performed prior to, and/or during display of the image.

Generally, a delay of the rendering process may cause an addition of more buffers. It may therefore be preferable to use a primary buffer, since use of a secondary buffer may lead to additional memory resources that may not be available (e.g. for a web server). In some embodiments, a graphics processing unit (GPU) based rendering may be performed that can enable additional memory resources for buffering. Accordingly, in some embodiments, rendering may be delayed. For example, although a refinement tile numbered “1” may be received, rendering may be delayed until bytes corresponding refinement tiles numbered “2” are received. This way, the computing device may be able to queue the rendering process, resulting in minimal perceived flicker. Proceeding recursively, the input image may be buffered until refinement tiles that can be used to paint the next level of refinement tiles (e.g., with at least the next number after the numbering of the previously painted refinement tile). That may enable an encoding phase to perform saliency path planning, and may help create a predictable and consistent update pattern that may avoid specific movement patterns like. Additional and/or alternate rendering processes may be possible, such as, for example, updating 256×256 tiles in a spiraling manner (starting from a center refinement tile and proceeding outward in a clockwise or anti-clockwise manner). However, a choice of a rendering process is based on reducing flicker.

In some embodiments, the progressively rendering of the decoded version of the encoded image may include pixel-wise rendering of the image. In such embodiments, a first number of pixels in a portion inside the bounding region may be rendered, and a second number of pixels in the portion outside the bounding region may be rendered, where the first number is greater than the second number. For example, a greater number of pixels in the salient portion of the image may be rendered, as compared to the non-salient portion, thereby rendering the salient portion first, and focusing a viewer's attention onto the salient portion of the image. For example, a location of faces in an image may be determined, and 20% more bits may be allocated to rendering the regions of the image that include the faces.

One way to reduce perceptible flickering may be to make successive rendering updates less noticeable. As data for different regions, such as different refinement tiles, may be received at different times, a smoothing process may be applied to a boundary between refinement tiles for which all the data has been received and refinement tiles for which incomplete data has been received. In some embodiments, the progressively rendering of the decoded version of the encoded image may include performing spatial smoothing of the image being rendered by rendering a boundary of the bounding region to maintain smoothness between a portion inside the bounding region and the portion outside the bounding region. For example, a boundary between a high resolution portion of a rendered image, and an adjoining low resolution portion, may be made to appear less sharp. For example, the boundary may be initially rendered in a slightly blurred version, or with an intermediate resolution between the high resolution of the salient portion inside the bounding region and a lower resolution of the non-salient portion outside the bounding region. In some embodiments, the progressive rendering of the decoded version of the encoded image may include performing spatial smoothing of the image being rendered by applying a non-separable interpolation algorithm.

In some embodiments, the progressively rendering of the decoded version of the encoded image may include performing temporal smoothing of the image being rendered. In some embodiments, the performing of the temporal smoothing may include gradually blending high frequency portions of the image over time. For example, high frequency portions of an image may be gradually blended in during the rendering process. In some embodiments, the performing of the temporal smoothing may include performing variable filtering with temporal variance based on one or more frequency portions of the image. For example, portions of the image may be rendered over time based on frequency ranges. For example, portions corresponding to higher frequencies may be rendered first, and portions corresponding to lower frequencies may be rendered in succession, with temporal blending.

As indicated, identifying the salient portions of an image has high relevance. As described, such information may be represented by a saliency map that can be visualized as a heat map or RGB image, where the more salient parts are represented by a red color and the less salient portions are represented by a blue color. The heat map may comprise a spectrum of hues between red and blue colors.

In some embodiments, a full resolution image may be used to identify the salient portions of the image. Detecting the salient portions may be performed at the time of encoding the image. Also, for example, the salient portions may be detected by a human being and identified as such in an image. For example, one or more objects in an image (e.g., corresponding to relevant subjects in the image) may be identified as salient portions. For example, in an image with a corporate logo, the portion including the logo, and/or a tagline, may be identified as salient portions. In some embodiments, a machine learning model may be trained to identify salient portions in an image (e.g., an object detection model), generate a heat map, and/or a sequential numbering of refinement tiles that constitute the image.

For example, saliency prediction models aim at predicting which regions in an image will attract human attention. To predict saliency effectively, the power of deep neural nets may be leveraged to consider both high level semantic signals like face, objects, shapes etc., as well as low or medium level signals such as color, intensity, texture, and so forth. The deep neural net may be trained on a large scale public gaze, and/or saliency data set, so that a predicted saliency may mimic human gaze and/or visual fixation behavior on each image. The deep neural net may take an image as an input and output a saliency map, which can serve as a visual importance map, and therefore enable determining of an ordering for decoding for each region in the image.

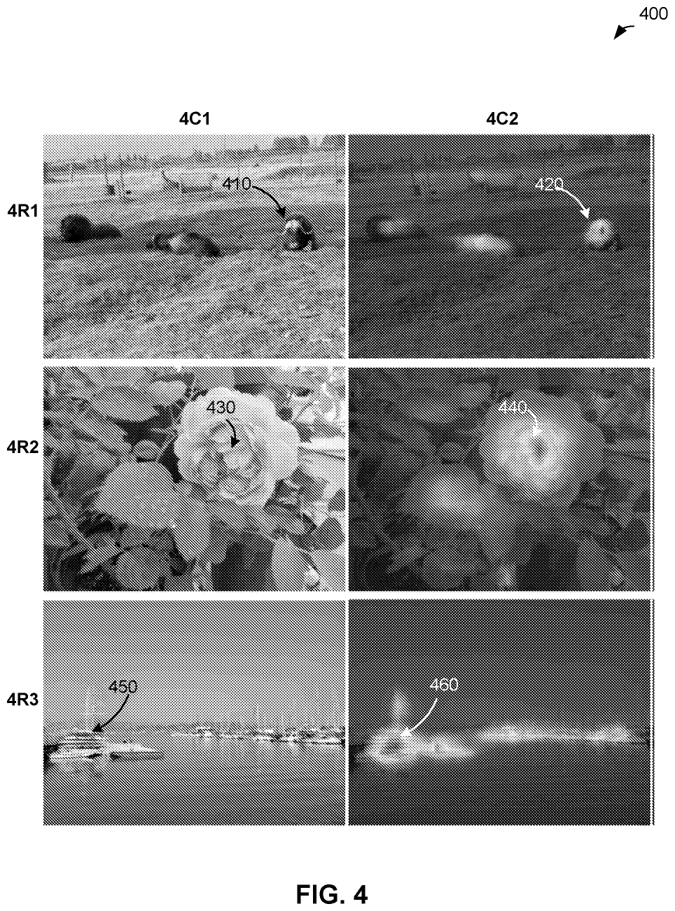

FIG. 4 illustrates example images with respective saliency maps, in accordance with example embodiments. For example, images in first column 4C1 are full resolution images and images in second column 4C2 are saliency maps of the images in first column 4C1. For example, first row 4R1 illustrates an image with three animals in a field, and face portion 410 of the animal to the right is visible. Accordingly, the corresponding saliency map in second column 4C2 of first row 4R1 has a high saliency portion 420 that corresponds to face portion 410. As another example, second row 4R2 illustrates an image of a flower with a central portion 430 of the flower. Accordingly, the corresponding saliency map in second column 4C2 of second row 4R2 has a high saliency portion 440 that corresponds to central portion 430. Also, for example, third row 4R3 illustrates a plurality of boats anchored in a harbor, with primary boat 450. Accordingly, the corresponding saliency map in second column 4C2 of third row 4R3 has a high saliency portion 460 that corresponds to primary boat 450. In some embodiments, as described herein with respect to image 320 of FIG. 3, each image in first column 4C1 may be tiled with square tiles that are sequentially numbered, with one or more square tiles numbered “1” corresponding to each of face portion 410 of the animal, central portion 430 of the flower, and primary boat 450. Square tiles surrounding the square tiles numbered “1” may be numbered “2,” and such numbering may continue outward in a concentric manner. Such information may be encoded as part of the image, and decoding may be performed based on the sequence of square tiles, starting with square tiles numbered “1.”

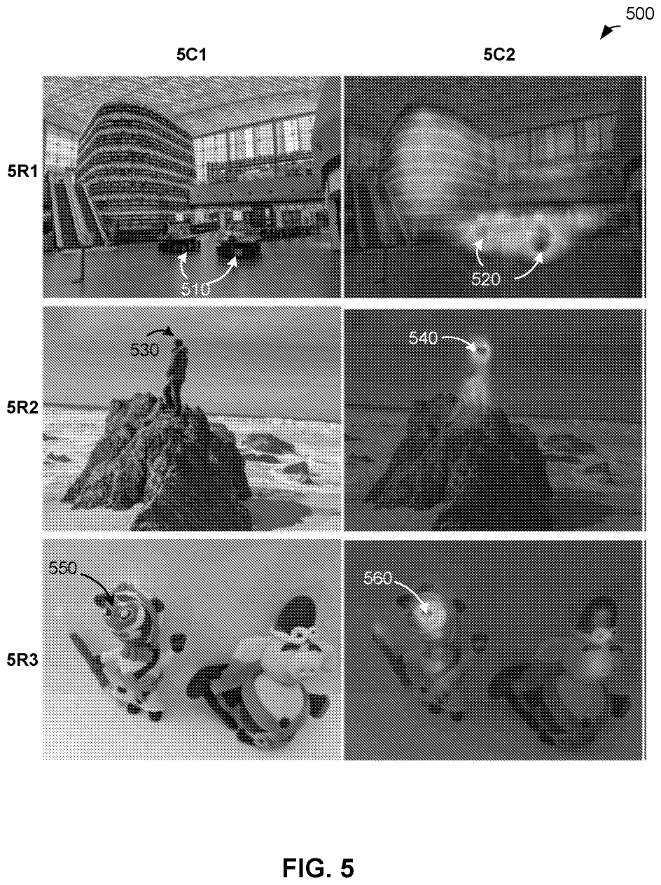

FIG. 5 illustrates additional example images with respective saliency maps, in accordance with example embodiments. For example, images in first column 5C1 are full resolution images and images in second column 5C2 are saliency maps of the images in first column 5C1. For example, first row 5R1 illustrates an image of a lobby, with two counters 510. Accordingly, the corresponding saliency map in second column 5C2 of first row 5R1 has a high saliency portion 520 that corresponds to two counters 510. As another example, second row 5R2 illustrates an image of a rock formation by the sea with a head portion 530 of a person on the rock formation. Accordingly, the corresponding saliency map in second column 5C2 of second row 5R2 has a high saliency portion 540 that corresponds to head portion 530 of a person on the rock formation. Also, for example, third row 5R3 illustrates two toys, with a face portion 550 of a first toy. Accordingly, the corresponding saliency map in second column 5C2 of third row 5R3 has a high saliency portion 560 that corresponds to face portion 550 of the first toy. In some embodiments, as described herein with respect to image 320 of FIG. 3, each image in first column 5C1 may be tiled with square tiles that are sequentially numbered, with one or more square tiles numbered “1” corresponding to each of two counters 510, head portion 530 of a person on the rock formation, and face portion 550 of the first toy. Square tiles surrounding the square tiles numbered “1” may be numbered “2,” and such numbering may continue outward in a concentric manner. Such information may be encoded as part of the image, and decoding may be performed based on the sequence of square tiles, starting with square tiles numbered “1.”

In some embodiments, an indication may be provided of a progress of the rendering process. This may allow a user to know if the image is in a final state of rendering. For example, in some embodiments, the method may involve providing, via a graphical user interface of the computing device, a visual indication of a level of progress in the progressive rendering of the decoded version of the encoded image. In some embodiments, the visual indication may include a horizontal slider indicating the level of progress. For example, a slider bar may be provided to indicate a progress status of the rendering.

In some embodiments, the providing of the visual indication may include overlaying the image being rendered with a temporary image that indicates that the image is being rendered, and removing the temporary image after the rendering is complete. For example, a pattern may be overlaid over the image being rendered to indicate that the image is being rendered, and the overlaid pattern may then be removed to indicate that the image has been rendered.

In some embodiments, the receiving of the plurality of bytes of the encoded image may occur over a communications network, and the progressively rendering of the decoded version of the encoded image may be based on one or more network characteristics of the communications network. For example, the one or more network characteristics may include an available bandwidth, network strength, a type of network (e.g., wired, wireless, near field communication, 4G, 5G), secured or unsecured, and so forth. The progressively rendering of the decoded version of the encoded image may be modulated to optimize available network resources. For example, in situations of low network bandwidth and/or availability, a user may be provided control over data usage, the size of an image download, the amount of rendering, and so forth. Also, in some embodiments, bytes may arrive in batches, and the image may be rendered batch-wise in a gradually sharpening manner.

Generally, based on different levels of sensory perceptions, different users may have different user experiences while viewing images that are being loaded (e.g., an image in a webpage). For example, some users may be more sensitive to flickering. Also, for example, some users may not wish to view a downloaded image in its entirety. Accordingly, progressively rendering images may improve user experience. In some embodiments, flickering may be further reduced for highly sensitive perceptions of flickering, especially in relation to high sensitivity to changes in light intensity. In some embodiments, such light sensitivity may depend on an ambient or environmental lighting where a computing device, such as a mobile phone, may be located. In some embodiments, the progressively rendering of the decoded version of the encoded image may include displaying the decoded version of the encoded image after rendering is complete. For example, to minimize and/or eliminate perceptible flickering, an image may be rendered before it is displayed.

In some embodiments, the method may involve providing, via a graphical user interface of the computing device, a user selectable option to select an amount of rendering of the progressively rendering of the decoded version of the encoded image. The method may further involve receiving, via the graphical user interface, user indication of the amount of rendering. For example, a horizontal slider bar may be provided, and a user may adjust the slider bar to indicate a desired level of rendering. Accordingly, the progressively rendering of the salient portion may be performed based on the user indication. As pre-attentive cues may be perceived differently by different users, user control over the rendering process may be desirable.

In some embodiments, the method may involve providing, via a graphical user interface of a camera of the computing device, a preview of an image to be captured by the camera. For example, a camera feature can provide a preview of the image to be captured. Generally, such a preview can be provided with optional controls to adjust an aperture value, a brightness setting, a picture mode, an adjustment of the focus of the image, whether or not to use a flash lighting, an ability to focus on one or more objects, and so forth. The method may also involve detecting one or more objects in the preview of the image, wherein the one or more objects represent candidate salient portions. For example, one or more objects in the field of view can be detected, such as a person, a building, and so forth. The method may further involve displaying, via the graphical user interface, the one or more detected objects. For example, the one or more detected objects in the field of view can be highlighted with bounding boxes. For example, the person can be framed within a first bounding box, the building can be framed within a second bounding box, and so forth. The method may also involve receiving user selection of an object of the one or more detected objects. For example, the user may select an object among the detected objects. For example, the user may select the person framed within the first bounding box.

The method may additionally involve, subsequent to a capture of the image by the camera, encoding the captured image with the selected object as the salient portion of the encoded image. For example, after the user captures the image, the captured image can be encoded, and information about the selected object can be encoded as a salient portion. For example, the captured image may include the person and the building, and the person, or a portion of the person, such as a face, or the eyes, may be encoded as a salient portion in the image. In some embodiments, the detection of the one or more objects in the preview of the image may be based on a machine learning model trained to detect objects in an image. In some embodiments, the detecting of the one or more objects in the preview of the image may involve identifying the candidate salient portions by tracking a pupil movement of a user of the camera.

For example, when a user is previewing an image via a camera preview feature, a machine learning model may detect one or more candidate salient portions in the previewed image and a user can be provided an option to select a preferred salient portion from the one or more candidate salient portions. The camera can then encode the captured image based on the selected salient portion. In some embodiments, the selection may be made automatically by taking a front facing camera and tracking eye or pupil movement during the capture of the image. Such eye tracking may indicate significant and/or relevant objects in the image (e.g., relevant to the user), and therefore indicate a salient portion.

### Training Machine Learning Models for Generating Inferences/Predictions

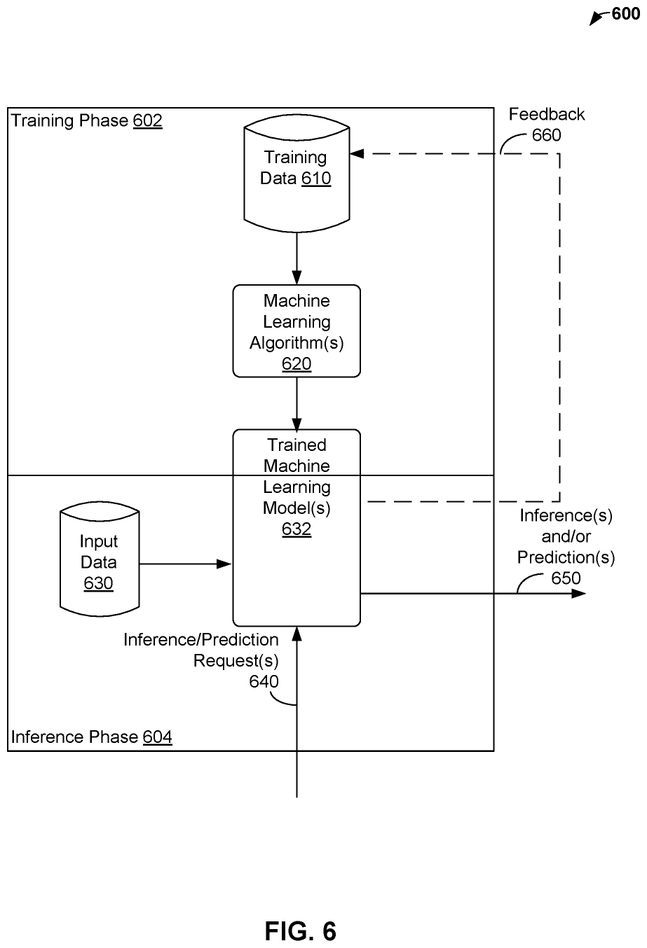

FIG. 6 shows diagram 600 illustrating a training phase 602 and an inference phase 604 of trained machine learning model(s) 632, in accordance with example embodiments. Some machine learning techniques involve training one or more machine learning algorithms, on an input set of training data to recognize patterns in the training data and provide output inferences and/or predictions about (patterns in the) training data. The resulting trained machine learning algorithm can be termed as a trained machine learning model. For example, FIG. 6 shows training phase 602 where one or more machine learning algorithms 620 are being trained on training data 610 to become trained machine learning model 632. Then, during inference phase 604, trained machine learning model 632 can receive input data 630 and one or more inference/prediction requests 640 (perhaps as part of input data 630) and responsively provide as an output one or more inferences and/or predictions 650.

As such, trained machine learning model(s) 632 can include one or more models of one or more machine learning algorithms 620. Machine learning algorithm(s) 620 may include, but are not limited to: an artificial neural network (e.g., a convolutional neural network, a recurrent neural network, a Bayesian network, a hidden Markov model, a Markov decision process, a logistic regression function, a support vector machine, a suitable statistical machine learning algorithm, and/or a heuristic machine learning system). Machine learning algorithm(s) 620 may be supervised or unsupervised, and may implement any suitable combination of online and offline learning.

In some examples, machine learning algorithm(s) 620 and/or trained machine learning model(s) 632 can be accelerated using on-device coprocessors, such as graphic processing units (GPUs), tensor processing units (TPUs), digital signal processors (DSPs), and/or application specific integrated circuits (ASICs). Such on-device coprocessors can be used to speed up machine learning algorithm(s) 620 and/or trained machine learning model(s) 632. In some examples, trained machine learning model(s) 632 can be trained, reside and execute to provide inferences on a particular computing device, and/or otherwise can make inferences for the particular computing device.

During training phase 602, machine learning algorithm(s) 620 can be trained by providing at least training data 610 as training input using unsupervised, supervised, semi-supervised, and/or reinforcement learning techniques. Unsupervised learning involves providing a portion (or all) of training data 610 to machine learning algorithm(s) 620 and machine learning algorithm(s) 620 determining one or more output inferences based on the provided portion (or all) of training data 610. Supervised learning involves providing a portion of training data 610 to machine learning algorithm(s) 620, with machine learning algorithm(s) 620 determining one or more output inferences based on the provided portion of training data 610, and the output inference(s) are either accepted or corrected based on correct results associated with training data 610. In some examples, supervised learning of machine learning algorithm(s) 620 can be governed by a set of rules and/or a set of labels for the training input, and the set of rules and/or set of labels may be used to correct inferences of machine learning algorithm(s) 620.

Semi-supervised learning involves having correct results for part, but not all, of training data 610. During semi-supervised learning, supervised learning is used for a portion of training data 610 having correct results, and unsupervised learning is used for a portion of training data 610 not having correct results. Reinforcement learning involves machine learning algorithm(s) 620 receiving a reward signal regarding a prior inference, where the reward signal can be a numerical value. During reinforcement learning, machine learning algorithm(s) 620 can output an inference and receive a reward signal in response, where machine learning algorithm(s) 620 are configured to try to maximize the numerical value of the reward signal. In some examples, reinforcement learning also utilizes a value function that provides a numerical value representing an expected total of the numerical values provided by the reward signal over time. In some examples, machine learning algorithm(s) 620 and/or trained machine learning model(s) 632 can be trained using other machine learning techniques, including but not limited to, incremental learning and curriculum learning.

In some examples, machine learning algorithm(s) 620 and/or trained machine learning model(s) 632 can use transfer learning techniques. For example, transfer learning techniques can involve trained machine learning model(s) 632 being pre-trained on one set of data and additionally trained using training data 610. More particularly, machine learning algorithm(s) 620 can be pre-trained on data from one or more computing devices and a resulting trained machine learning model provided to a particular computing device, where the particular computing device is intended to execute the trained machine learning model during inference phase 604. Then, during training phase 602, the pre-trained machine learning model can be additionally trained using training data 610, where training data 610 can be derived from kernel and non-kernel data of the particular computing device. This further training of the machine learning algorithm(s) 620 and/or the pre-trained machine learning model using training data 610 of the particular computing device's data can be performed using either supervised or unsupervised learning. Once machine learning algorithm(s) 620 and/or the pre-trained machine learning model has been trained on at least training data 610, training phase 602 can be completed. The trained resulting machine learning model can be utilized as at least one of trained machine learning model(s) 632.

In particular, once training phase 602 has been completed, trained machine learning model(s) 632 can be provided to a computing device, if not already on the computing device. Inference phase 604 can begin after trained machine learning model(s) 632 are provided to the particular computing device.

During inference phase 604, trained machine learning model(s) 632 can receive input data 630 and generate and output one or more corresponding inferences and/or predictions 650 about input data 630. As such, input data 630 can be used as an input to trained machine learning model(s) 632 for providing corresponding inference(s) and/or prediction(s) 650 to kernel components and non-kernel components. For example, trained machine learning model(s) 632 can generate inference(s) and/or prediction(s) 650) in response to one or more inference/prediction requests 640. In some examples, trained machine learning model(s) 632 can be executed by a portion of other software. For example, trained machine learning model(s) 632 can be executed by an inference or prediction daemon to be readily available to provide inferences and/or predictions upon request. Input data 630 can include data from the particular computing device executing trained machine learning model(s) 632 and/or input data from one or more computing devices other than the particular computing device.

Input data 630) can include a collection of images provided by one or more sources. The collection of images can include images of an object, such as a human face, images of multiple objects, and/or other images. Other types of input data are possible as well. Input data 630 can be labeled images that indicate a preference for a choice of a bounding region, a choice for a rendering style, a choice for salient portions in an image, and so forth.

Inference(s) and/or prediction(s) 650 can include output images, output salient portions, output saliency maps, output sequentially ordered refinement tiles, output candidate salient portions in an image preview, and/or other output data produced by trained machine learning model(s) 632 operating on input data 630 (and training data 610). In some examples, trained machine learning model(s) 632 can use output inference(s) and/or prediction(s) 650 as input feedback 660. Trained machine learning model(s) 632 can also rely on past inferences as inputs for generating new inferences.

Deep neural nets for saliency prediction can be examples of machine learning algorithm(s) 620. After training, the trained version of deep neural nets can be examples of trained machine learning model(s) 632. In this approach, an example of inference/prediction request(s) 640 can be a request to predict a saliency map for an input image and a corresponding example of inferences and/or prediction(s) 650 can be an output saliency map or heat map.

In some examples, a single computing device (“CD_SOLO”) can include the trained version of the machine learning model, perhaps after training the machine learning model. Then, the computing device CD_SOLO can receive requests to predict a saliency map, and use the trained version of the machine learning model to predict the saliency map.

In some examples, two or more computing devices, such as a first client device (“CD_CLI”) and a server device (“CD_SRV”) can be used to provide the output; e.g., a first computing device CD_CLI can generate and send requests to predict a saliency map to a second computing device CD_SRV. Then, CD_SRV can use the trained version of the machine learning model to predict the saliency map. Then, upon reception of responses to the requests, CD_CLI can provide the requested output via one or more control interfaces.

### Example Data Network

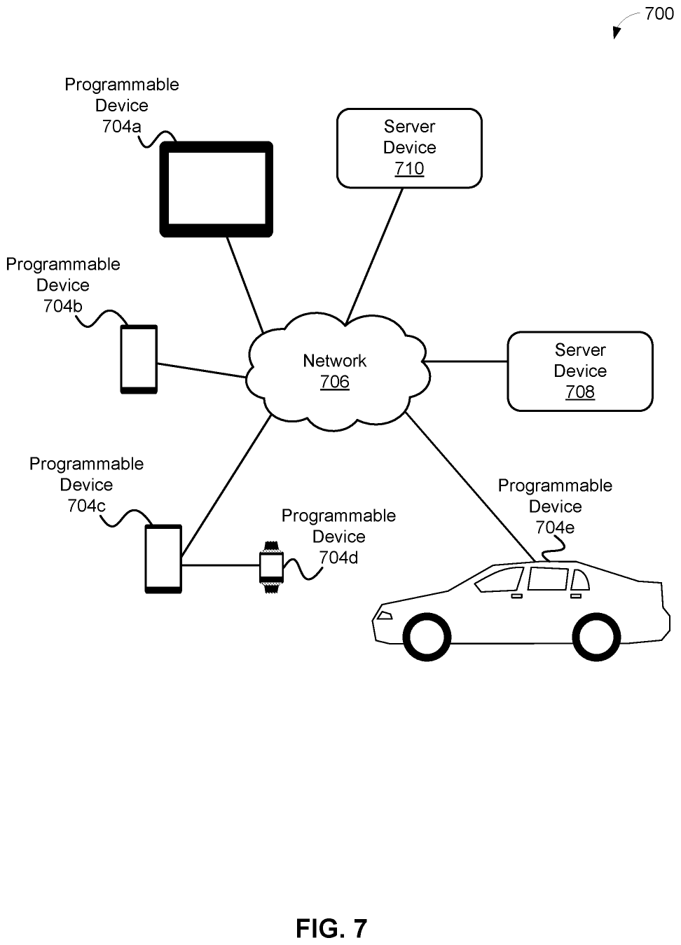

FIG. 7 depicts a distributed computing architecture 700, in accordance with example embodiments. Distributed computing architecture 700 includes server devices 708, 710 that are configured to communicate, via network 706, with programmable devices 704a, 704b, 704c, 704d, 704e. Network 706 may correspond to a local area network (LAN), a wide area network (WAN), a WLAN, a WWAN, a corporate intranet, the public Internet, or any other type of network configured to provide a communications path between networked computing devices. Network 706 may also correspond to a combination of one or more LANs, WANs, corporate intranets, and/or the public Internet.

Although FIG. 7 only shows five programmable devices, distributed application architectures may serve tens, hundreds, or thousands of programmable devices. Moreover, programmable devices 704a, 704b, 704c, 704d, 704e (or any additional programmable devices) may be any sort of computing device, such as a mobile computing device, desktop computer, wearable computing device, head-mountable device (HMD), network terminal, a mobile computing device, and so on. In some examples, such as illustrated by programmable devices 704a, 704b, 704c, 704e, programmable devices can be directly connected to network 706. In other examples, such as illustrated by programmable device 704d, programmable devices can be indirectly connected to network 706 via an associated computing device, such as programmable device 704c. In this example, programmable device 704c can act as an associated computing device to pass electronic communications between programmable device 704d and network 706. In other examples, such as illustrated by programmable device 704e, a computing device can be part of and/or inside a vehicle, such as a car, a truck, a bus, a boat or ship, an airplane, etc. In other examples not shown in FIG. 7, a programmable device can be both directly and indirectly connected to network 706.

Server devices 708, 710 can be configured to perform one or more services, as requested by programmable devices 704a-704e. For example, server device 708 and/or 710 can provide content to programmable devices 704a-704e. The content can include, but is not limited to, web pages, hypertext, scripts, binary data such as compiled software, images, audio, and/or video. The content can include compressed and/or uncompressed content. The content can be encrypted and/or unencrypted. Other types of content are possible as well.

As another example, server device 708 and/or 710 can provide programmable devices 704a-704e with access to software for database, search, computation, graphical, audio, video, World Wide Web/Internet utilization, and/or other functions. Many other examples of server devices are possible as well.

### Computing Device Architecture

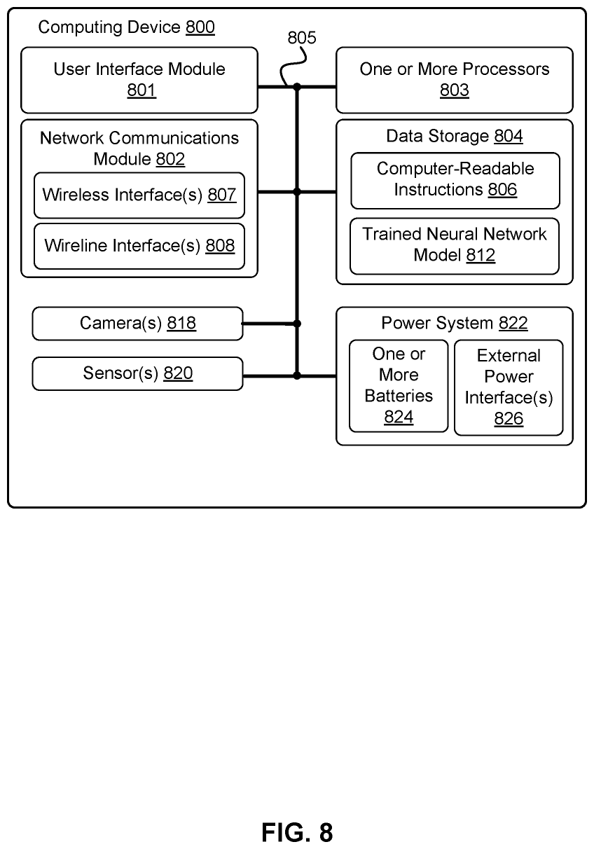

FIG. 8 is a block diagram of an example computing device 800, in accordance with example embodiments. In particular, computing device 800 shown in FIG. 8 can be configured to perform at least one function of and/or related to a deep neural network, a predicted saliency map, a predicted salient portion of an image, and/or method 1000.

Computing device 800 may include a user interface module 801, a network communications module 802, one or more processors 803, data storage 804, one or more cameras 818, one or more sensors 820, and power system 822, all of which may be linked together via a system bus, network, or other connection mechanism 805.

User interface module 801 can be operable to send data to and/or receive data from external user input/output devices. For example, user interface module 801 can be configured to send and/or receive data to and/or from user input devices such as a touch screen, a computer mouse, a keyboard, a keypad, a touch pad, a track ball, a joystick, a voice recognition module, and/or other similar devices. User interface module 801 can also be configured to provide output to user display devices, such as one or more cathode ray tubes (CRT), liquid crystal displays, light emitting diodes (LEDs), displays using digital light processing (DLP) technology, printers, light bulbs, and/or other similar devices, either now known or later developed. User interface module 801 can also be configured to generate audible outputs, with devices such as a speaker, speaker jack, audio output port, audio output device, earphones, and/or other similar devices. User interface module 801 can further be configured with one or more haptic devices that can generate haptic outputs, such as vibrations and/or other outputs detectable by touch and/or physical contact with computing device 800. In some examples, user interface module 801 can be used to provide a graphical user interface (GUI) for utilizing computing device 800.

Network communications module 802 can include one or more devices that provide one or more wireless interfaces 807 and/or one or more wireline interfaces 808 that are configurable to communicate via a network. Wireless interface(s) 807 can include one or more wireless transmitters, receivers, and/or transceivers, such as a Bluetooth™ transceiver, a Zigbee® transceiver, a Wi-Fi™ transceiver, a WiMAX™ transceiver, an LTE™ transceiver, and/or other type of wireless transceiver configurable to communicate via a wireless network. Wireline interface(s) 808 can include one or more wireline transmitters, receivers, and/or transceivers, such as an Ethernet transceiver, a Universal Serial Bus (USB) transceiver, or similar transceiver configurable to communicate via a twisted pair wire, a coaxial cable, a fiber-optic link, or a similar physical connection to a wireline network.

In some examples, network communications module 802 can be configured to provide reliable, secured, and/or authenticated communications. For each communication described herein, information for facilitating reliable communications (e.g., guaranteed message delivery) can be provided, perhaps as part of a message header and/or footer (e.g., packet/message sequencing information, encapsulation headers and/or footers, size/time information, and transmission verification information such as cyclic redundancy check (CRC) and/or parity check values). Communications can be made secure (e.g., be encoded or encrypted) and/or decrypted/decoded using one or more cryptographic protocols and/or algorithms, such as, but not limited to, Data Encryption Standard (DES), Advanced Encryption Standard (AES), a Rivest-Shamir-Adelman (RSA) algorithm, a Diffie-Hellman algorithm, a secure sockets protocol such as Secure Sockets Layer (SSL) or Transport Layer Security (TLS), and/or Digital Signature Algorithm (DSA). Other cryptographic protocols and/or algorithms can be used as well or in addition to those listed herein to secure (and then decrypt/decode) communications.

One or more processors 803 can include one or more general purpose processors, and/or one or more special purpose processors (e.g., digital signal processors, tensor processing units (TPUs), graphics processing units (GPUs), application specific integrated circuits, etc.). One or more processors 803 can be configured to execute computer-readable instructions 806 that are contained in data storage 804 and/or other instructions as described herein.

Data storage 804 can include one or more non-transitory computer-readable storage media that can be read and/or accessed by at least one of one or more processors 803. The one or more computer-readable storage media can include volatile and/or non-volatile storage components, such as optical, magnetic, organic or other memory or disc storage, which can be integrated in whole or in part with at least one of one or more processors 803. In some examples, data storage 804 can be implemented using a single physical device (e.g., one optical, magnetic, organic or other memory or disc storage unit), while in other examples, data storage 804 can be implemented using two or more physical devices.

Data storage 804 can include computer-readable instructions 806 and perhaps additional data. In some examples, data storage 804 can include storage required to perform at least part of the herein-described methods, scenarios, and techniques and/or at least part of the functionality of the herein-described devices and networks. In some examples, data storage 804 can include storage for a trained neural network model 812. In particular of these examples, computer-readable instructions 806 can include instructions that, when executed by processor(s) 803, enable computing device 800 to provide for some or all of the functionality of trained neural network model 812.

In some examples, computing device 800 can include one or more cameras 818. Camera(s) 818 can include one or more image capture devices, such as still and/or video cameras, equipped to capture light and record the captured light in one or more images; that is, camera(s) 818 can generate image(s) of captured light. The one or more images can be one or more still images and/or one or more images utilized in video imagery. Camera(s) 818 can capture light and/or electromagnetic radiation emitted as visible light, infrared radiation, ultraviolet light, and/or as one or more other frequencies of light.

In some examples, computing device 800 can include one or more sensors 820. Sensors 820 can be configured to measure conditions within computing device 800 and/or conditions in an environment of computing device 800 and provide data about these conditions. For example, sensors 820 can include one or more of: (i) sensors for obtaining data about computing device 800, such as, but not limited to, a thermometer for measuring a temperature of computing device 800, a battery sensor for measuring power of one or more batteries of power system 822, and/or other sensors measuring conditions of computing device 800; (ii) an identification sensor to identify other objects and/or devices, such as, but not limited to, a Radio Frequency Identification (RFID) reader, proximity sensor, one-dimensional barcode reader, two-dimensional barcode (e.g., Quick Response (QR) code) reader, and a laser tracker, where the identification sensors can be configured to read identifiers, such as RFID tags, barcodes, QR codes, and/or other devices and/or object configured to be read and provide at least identifying information; (iii) sensors to measure locations and/or movements of computing device 800, such as, but not limited to, a tilt sensor, a gyroscope, an accelerometer, a Doppler sensor, a GPS device, a sonar sensor, a radar device, a laser-displacement sensor, and a compass; (iv) an environmental sensor to obtain data indicative of an environment of computing device 800, such as, but not limited to, an infrared sensor, an optical sensor, a light sensor, a biosensor, a capacitive sensor, a touch sensor, a temperature sensor, a wireless sensor, a radio sensor, a movement sensor, a microphone, a sound sensor, an ultrasound sensor and/or a smoke sensor; and/or (v) a force sensor to measure one or more forces (e.g., inertial forces and/or G-forces) acting about computing device 800, such as, but not limited to one or more sensors that measure: forces in one or more dimensions, torque, ground force, friction, and/or a zero moment point (ZMP) sensor that identifies ZMPs and/or locations of the ZMPs. Many other examples of sensors 820 are possible as well.

Power system 822 can include one or more batteries 824 and/or one or more external power interfaces 826 for providing electrical power to computing device 800. Each battery of the one or more batteries 824 can, when electrically coupled to the computing device 800, act as a source of stored electrical power for computing device 800. One or more batteries 824 of power system 822 can be configured to be portable. Some or all of one or more batteries 824 can be readily removable from computing device 800. In other examples, some or all of one or more batteries 824 can be internal to computing device 800, and so may not be readily removable from computing device 800. Some or all of one or more batteries 824 can be rechargeable. For example, a rechargeable battery can be recharged via a wired connection between the battery and another power supply, such as by one or more power supplies that are external to computing device 800 and connected to computing device 800 via the one or more external power interfaces. In other examples, some or all of one or more batteries 824 can be non-rechargeable batteries.

One or more external power interfaces 826 of power system 822 can include one or more wired-power interfaces, such as a USB cable and/or a power cord, that enable wired electrical power connections to one or more power supplies that are external to computing device 800. One or more external power interfaces 826 can include one or more wireless power interfaces, such as a Qi wireless charger, that enable wireless electrical power connections, such as via a Qi wireless charger, to one or more external power supplies. Once an electrical power connection is established to an external power source using one or more external power interfaces 826, computing device 800 can draw electrical power from the external power source the established electrical power connection. In some examples, power system 822 can include related sensors, such as battery sensors associated with the one or more batteries or other types of electrical power sensors.

### Cloud-Based Servers

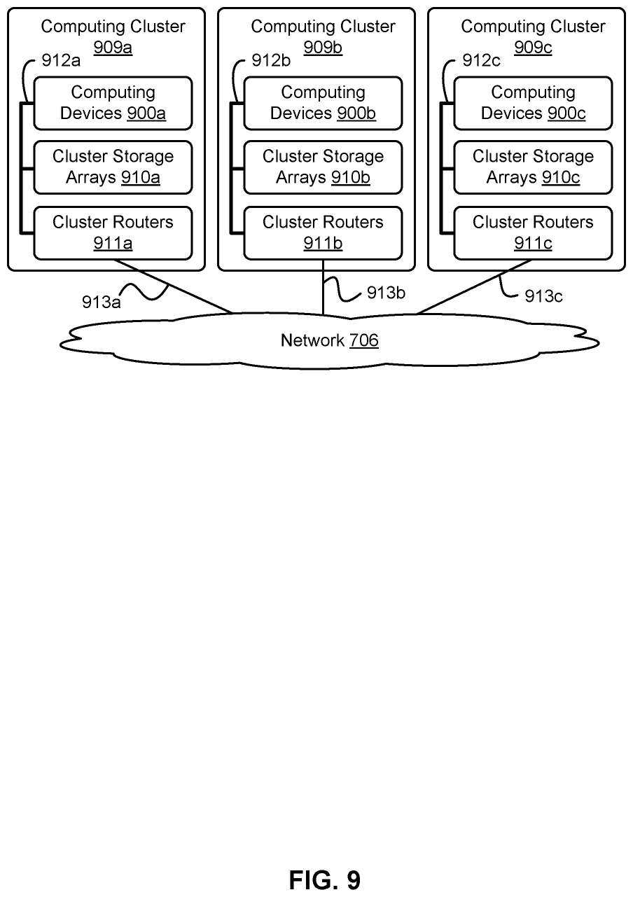

FIG. 9 depicts a network 706 of computing clusters 909a, 909b, 909c arranged as a cloud-based server system in accordance with an example embodiment. Computing clusters 909a, 909b, 909c can be cloud-based devices that store program logic and/or data of cloud-based applications and/or services; e.g., perform at least one function of and/or related to a deep neural network, a predicted saliency map, a predicted salient portion, a predicted bounding region, and/or method 1000.

In some embodiments, computing clusters 909a, 909b, 909c can be a single computing device residing in a single computing center. In other embodiments, computing clusters 909a, 909b, 909c can include multiple computing devices in a single computing center, or even multiple computing devices located in multiple computing centers located in diverse geographic locations. For example, FIG. 9 depicts each of computing clusters 909a, 909b, and 909c residing in different physical locations.

In some embodiments, data and services at computing clusters 909a, 909b, 909c can be encoded as computer readable information stored in non-transitory, tangible computer readable media (or computer readable storage media) and accessible by other computing devices. In some embodiments, computing clusters 909a, 909b, 909c can be stored on a single disk drive or other tangible storage media, or can be implemented on multiple disk drives or other tangible storage media located at one or more diverse geographic locations.

FIG. 9 depicts a cloud-based server system in accordance with an example embodiment. In FIG. 9, functionality of a deep neural network, and/or a computing device can be distributed among computing clusters 909a, 909b, 909c. Computing cluster 909a can include one or more computing devices 900a, cluster storage arrays 910a, and cluster routers 911a connected by a local cluster network 912a. Similarly, computing cluster 909b can include one or more computing devices 900b, cluster storage arrays 910b, and cluster routers 911b connected by a local cluster network 912b. Likewise, computing cluster 909c can include one or more computing devices 900c, cluster storage arrays 910c, and cluster routers 911c connected by a local cluster network 912c.

In some embodiments, each of computing clusters 909a, 909b, and 909c can have an equal number of computing devices, an equal number of cluster storage arrays, and an equal number of cluster routers. In other embodiments, however, each computing cluster can have different numbers of computing devices, different numbers of cluster storage arrays, and different numbers of cluster routers. The number of computing devices, cluster storage arrays, and cluster routers in each computing cluster can depend on the computing task or tasks assigned to each computing cluster.

In computing cluster 909a, for example, computing devices 900a can be configured to perform various computing tasks of convolutional neural network, confidence learning, and/or a computing device. In one embodiment, the various functionalities of a convolutional neural network, confidence learning, and/or a computing device can be distributed among one or more of computing devices 900a, 900b, 900c. Computing devices 900b and 900c in respective computing clusters 909b and 909c can be configured similarly to computing devices 900a in computing cluster 909a. On the other hand, in some embodiments, computing devices 900a, 900b, and 900c can be configured to perform different functions.

In some embodiments, computing tasks and stored data associated with a convolutional neural networks, and/or a computing device can be distributed across computing devices 900a. 900b, and 900c based at least in part on the processing requirements of a convolutional neural networks, and/or a computing device, the processing capabilities of computing devices 900a, 900b, 900c, the latency of the network links between the computing devices in each computing cluster and between the computing clusters themselves, and/or other factors that can contribute to the cost, speed, fault-tolerance, resiliency, efficiency, and/or other design goals of the overall system architecture.

Cluster storage arrays 910a, 910b, 910c of computing clusters 909a, 909b, 909c can be data storage arrays that include disk array controllers configured to manage read and write access to groups of hard disk drives. The disk array controllers, alone or in conjunction with their respective computing devices, can also be configured to manage backup or redundant copies of the data stored in the cluster storage arrays to protect against disk drive or other cluster storage array failures and/or network failures that prevent one or more computing devices from accessing one or more cluster storage arrays.

Similar to the manner in which the functions of convolutional neural networks, and/or a computing device can be distributed across computing devices 900a, 900b, 900c of computing clusters 909a, 909b, 909c, various active portions and/or backup portions of these components can be distributed across cluster storage arrays 910a, 910b, 910c. For example, some cluster storage arrays can be configured to store one portion of the data of a convolutional neural network, and/or a computing device, while other cluster storage arrays can store other portion(s) of data of a convolutional neural network, and/or a computing device. Also, for example, some cluster storage arrays can be configured to store the data of a first convolutional neural network, while other cluster storage arrays can store the data of a second and/or third convolutional neural network. Additionally, some cluster storage arrays can be configured to store backup versions of data stored in other cluster storage arrays.

Cluster routers 911a, 911b, 911c in computing clusters 909a, 909b, 909c can include networking equipment configured to provide internal and external communications for the computing clusters. For example, cluster routers 911a in computing cluster 909a can include one or more internet switching and routing devices configured to provide (i) local area network communications between computing devices 900a and cluster storage arrays 910a via local cluster network 912a , and (ii) wide area network communications between computing cluster 909a and computing clusters 909b and 909c via wide area network link 913a to network 706. Cluster routers 911b and 911c can include network equipment similar to cluster routers 911a, and cluster routers 911b and 911c can perform similar networking functions for computing clusters 909b and 909b that cluster routers 911a perform for computing cluster 909a.

In some embodiments, the configuration of cluster routers 911a, 911b, 911c can be based at least in part on the data communication requirements of the computing devices and cluster storage arrays, the data communications capabilities of the network equipment in cluster routers 911a, 911b, 911c, the latency and throughput of local cluster networks 912a, 912b, 912c, the latency, throughput, and cost of wide area network links 913a, 913b, 913c, and/or other factors that can contribute to the cost, speed, fault-tolerance, resiliency, efficiency and/or other design criteria of the moderation system architecture.

### Example Methods of Operation

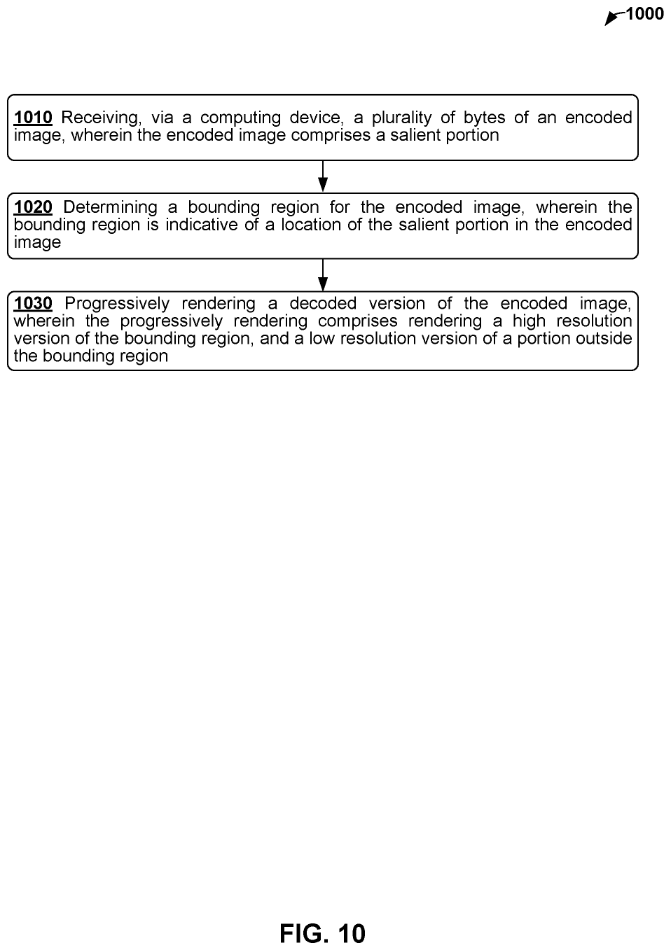

FIG. 10 is a flowchart of a method 1000, in accordance with example embodiments. Method 1000 can be executed by a computing device, such as computing device 800. Method 1000 can begin at block 1010, where the computing device can receive a plurality of bytes of an encoded image, wherein the encoded image comprises a salient portion.

At block 1020, the computing device can determine a bounding region for the encoded image, wherein the bounding region is indicative of a location of the salient portion in the encoded image.

At block 1030, the computing device can progressively render a decoded version of the encoded image, wherein the progressively rendering comprises rendering a high resolution version of the bounding region, and a low resolution version of a portion outside the bounding region.

In some embodiments, the bounding region may be square-shaped.

In some embodiments, the encoded image may be encoded in a JPEG-XL format.

In some embodiments, the salient portion may be identified during encoding of the image. In such embodiments, the encoded image may be partitioned into a plurality of sequentially ordered regions, wherein a lower position in the sequential ordering may be indicative of the salient portion of the image.

In some embodiments, the salient portion may be identified at the time the image is received. In such embodiments, the salient portion may be identified by applying a trained machine learning model.

In some embodiments, the progressively rendering of the decoded version of the encoded image may include performing spatial smoothing of the image being rendered by rendering a boundary of the bounding region to maintain smoothness between a portion inside the bounding region and the portion outside the bounding region.

In some embodiments, the progressively rendering of the decoded version of the encoded image may include performing spatial smoothing of the image being rendered by applying a non-separable interpolation algorithm.

In some embodiments, the progressively rendering of the decoded version of the encoded image may include performing temporal smoothing of the image being rendered. In some embodiments, the performing of the temporal smoothing may include gradually blending high frequency portions of the image over time. In some embodiments, the performing of the temporal smoothing may include performing variable filtering with temporal variance based on one or more frequency portions of the image.

In some embodiments, wherein the salient portion is a first salient portion, wherein the image includes a second salient portion, and wherein the determining of the bounding region involves determining the bounding region so as to prioritize rendering of the first salient portion and the second salient portion.

In some embodiments, the determining of the bounding region may include selecting, from a plurality of candidate bounding regions, a bounding region that prioritizes rendering of the salient portion.

In some embodiments, the method may involve determining a time to commence the progressively rendering of the decoded version of the encoded image. In some embodiments, the bounding region may be encoded by a sub-plurality of the plurality of bytes, and wherein the determining of the time may involve determining the time, by a decoder of the image, to be subsequent to receiving the sub-plurality of the plurality of bytes. In some embodiments, the determining of the time may be performed by an encoder of the image, and the method may further involve receiving the time to commence the progressively rendering with the receiving of the encoded image.

In some embodiments, the progressively rendering of the decoded version of the encoded image may include displaying the decoded version of the encoded image after rendering is complete.

In some embodiments, the method may involve providing, via a graphical user interface of the computing device, a user selectable option to select an amount of rendering of the progressively rendering of the decoded version of the encoded image. The method may further involve receiving, via the graphical user interface, user indication of the amount of rendering, and wherein the progressively rendering of the salient portion is performed based on the user indication.

In some embodiments, the method may involve providing, via a graphical user interface of the computing device, a visual indication of a level of progress in the progressive rendering of the decoded version of the encoded image. In some embodiments, the visual indication may include a horizontal slider indicating the level of progress. In some embodiments, the providing of the visual indication may include overlaying the image being rendered with a temporary image that indicates that the image is being rendered, and removing the temporary image after the rendering is complete.

In some embodiments, the receiving of the plurality of bytes of the encoded image may occur over a communications network, and wherein the progressively rendering of the decoded version of the encoded image may be based on one or more network characteristics of the communications network.

In some embodiments, the progressively rendering of the decoded version of the encoded image may involve pixel-wise rendering. In such embodiments, the method may involve rendering a first number of pixels in a portion inside the bounding region, and a second number of pixels in the portion outside the bounding region, wherein the first number is greater than the second number.

In some embodiments, the method may involve providing, via a graphical user interface of a camera of the computing device, a preview of an image to be captured by the camera. The method may also involve detecting one or more objects in the preview of the image, wherein the one or more objects represent candidate salient portions. The method may further involve displaying, via the graphical user interface, the one or more detected objects. The method may also involve receiving user selection of an object of the one or more detected objects. The method may additionally involve, subsequent to a capture of the image by the camera, encoding the captured image with the selected object as the salient portion of the encoded image. In some embodiments, the detecting of the one or more objects in the preview of the image may be based on a machine learning model trained to detect objects in an image. In some embodiments, the detecting of the one or more objects in the preview of the image may involve identifying the candidate salient portions by tracking a pupil movement of a user of the camera.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The above detailed description describes various features and functions of the disclosed systems, devices, and methods with reference to the accompanying figures. In the figures, similar symbols typically identify similar components, unless context dictates otherwise. The illustrative embodiments described in the detailed description, figures, and claims are not meant to be limiting. Other embodiments can be utilized, and other changes can be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the ladder diagrams, scenarios, and flow charts in the figures and as discussed herein, each block and/or communication may represent a processing of information and/or a transmission of information in accordance with example embodiments. Alternative embodiments are included within the scope of these example embodiments. In these alternative embodiments, for example, functions described as blocks, transmissions, communications, requests, responses, and/or messages may be executed out of order from that shown or discussed, including substantially concurrent or in reverse order, depending on the functionality involved. Further, more or fewer blocks and/or functions may be used with any of the ladder diagrams, scenarios, and flow charts discussed herein, and these ladder diagrams, scenarios, and flow charts may be combined with one another, in part or in whole.

A block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical functions or actions in the method or technique. The program code and/or related data may be stored on any type of computer readable medium such as a storage device including a disk or hard drive or other storage medium.

The computer readable medium may also include non-transitory computer readable media such as non-transitory computer-readable media that stores data for short periods of time like register memory, processor cache, and random access memory (RAM). The computer readable media may also include non-transitory computer readable media that stores program code and/or data for longer periods of time, such as secondary or persistent long term storage, like read only memory (ROM), optical or magnetic disks, compact-disc read only memory (CD-ROM), for example. The computer readable media may also be any other volatile or non-volatile storage systems. A computer readable medium may be considered a computer readable storage medium, for example, or a tangible storage device.

Moreover, a block that represents one or more information transmissions may correspond to information transmissions between software and/or hardware modules in the same physical device. However, other information transmissions may be between software modules and/or hardware modules in different physical devices.

While various aspects and embodiments have been disclosed herein, other aspects and embodiments will be apparent to those skilled in the art. The various aspects and embodiments disclosed herein are provided for explanatory purposes and are not intended to be limiting, with the true scope being indicated by the following claims.

1. A computer-implemented method, comprising:
receiving, via a computing device, a plurality of bytes of an encoded image, wherein the encoded image comprises a salient portion;
determining a bounding region for the encoded image, wherein the bounding region is indicative of a location of the salient portion in the encoded image; and
progressively rendering a decoded version of the encoded image, wherein the progressively rendering comprises rendering a high resolution version of the bounding region, and a low resolution version of a portion outside the bounding region.

2. The computer-implemented method of claim 1, wherein the bounding region is square-shaped.

3. The computer-implemented method of claim 1, wherein the encoded image is encoded in a JPEG-XL format.

4. The computer-implemented method of claim 1, wherein the salient portion is identified during encoding of the image.

5. The computer-implemented method of claim 4, wherein the encoded image is be partitioned into a plurality of sequentially ordered regions, wherein a lower position in the sequential ordering is indicative of the salient portion of the image.

6. The computer-implemented method of claim 1, wherein the salient portion is identified at the time the image is received.

7. The computer-implemented method of claim 6, wherein the salient portion is identified by applying a trained machine learning model.

8. The computer-implemented method of claim 1, wherein the progressively rendering of the decoded version of the encoded image comprises performing spatial smoothing of the image being rendered by rendering a boundary of the bounding region to maintain smoothness between a portion inside the bounding region and the portion outside the bounding region.

9. The computer-implemented method of claim 1, wherein the progressively rendering of the decoded version of the encoded image comprises performing spatial smoothing of the image being rendered by applying a non-separable interpolation algorithm.

10. The computer-implemented method of claim 1, wherein the progressively rendering of the decoded version of the encoded image comprises performing temporal smoothing of the image being rendered.

11. The computer-implemented method of claim 10, wherein the performing of the temporal smoothing comprises gradually blending high frequency portions of the image over time.

12. The computer-implemented method of claim 10, wherein the performing of the temporal smoothing comprises performing variable filtering with temporal variance based on one or more frequency portions of the image.

13. The computer-implemented method of claim 1, wherein the salient portion is a first salient portion, wherein the image comprises a second salient portion, and wherein the determining of the bounding region comprises determining the bounding region so as to prioritize rendering of the first salient portion and the second salient portion.

14. The computer-implemented method of claim 1, wherein the determining of the bounding region comprises selecting, from a plurality of candidate bounding regions, a bounding region that prioritizes rendering of the salient portion.

15. The computer-implemented method of claim 1, further comprising determining a time to commence the progressively rendering of the decoded version of the encoded image.

16. The computer-implemented method of claim 15, wherein the bounding region is encoded by a sub-plurality of the plurality of bytes, and wherein the determining of the time comprises determining the time, by a decoder of the image, to be subsequent to receiving the sub-plurality of the plurality of bytes.

17. The computer-implemented method of claim 15, wherein the determining of the time is performed by an encoder of the image, and the method further comprising receiving the time to commence the progressively rendering with the receiving of the encoded image.

18. The computer-implemented method of claim 1, wherein the progressively rendering of the decoded version of the encoded image comprises displaying the decoded version of the encoded image after rendering is complete.

19. The computer-implemented method of claim 1, further comprising:
providing, via a graphical user interface of the computing device, a user selectable option to select an amount of rendering of the progressively rendering of the decoded version of the encoded image;
receiving, via the graphical user interface, user indication of the amount of rendering, and wherein the progressively rendering of the salient portion is performed based on the user indication.

20. The computer-implemented method of claim 1, further comprising:
providing, via a graphical user interface of the computing device, a visual indication of a level of progress in the progressively rendering of the decoded version of the encoded image.

21. The computer-implemented method of claim 20, wherein the visual indication comprises a horizontal slider indicating the level of progress.

22. The computer-implemented method of claim 20, wherein the providing of the visual indication comprises:
overlaying the image being rendered with a temporary image that indicates that the image is being rendered; and
removing the temporary image after the rendering is complete.

23. The computer-implemented method of claim 1, wherein the receiving of the plurality of bytes of the encoded image occurs over a communications network, and wherein the progressively rendering of the decoded version of the encoded image is based on one or more network characteristics of the communications network.

24. The computer-implemented method of claim 1, wherein the progressively rendering of the decoded version of the encoded image comprises pixel-wise rendering, and the method further comprises:
rendering a first number of pixels in a portion inside the bounding region, and a second number of pixels in the portion outside the bounding region, wherein the first number is greater than the second number.

25. The computer-implemented method of claim 1, further comprising:
providing, via a graphical user interface of a camera of the computing device, a preview of an image to be captured by the camera;
detecting one or more objects in the preview of the image, wherein the one or more objects represent candidate salient portions;
displaying, via the graphical user interface, the one or more detected objects;
receiving user selection of an object of the one or more detected objects; and
subsequent to a capture of the image by the camera, encoding the captured image with the selected object as the salient portion of the encoded image.

26. The computer-implemented method of claim 25, wherein the detecting of the one or more objects in the preview of the image is based on a machine learning model trained to detect objects in an image.

27. The computer-implemented method of claim 25, wherein the detecting of the one or more objects in the preview of the image further comprises:
identifying the candidate salient portions by tracking an eye movement of a user of the camera.

28. A computing device, comprising:
one or more processors; and
data storage, wherein the data storage has stored thereon computer-executable instructions that, when executed by the one or more processors, cause the computing device to carry out functions comprising:
receiving a plurality of bytes of an encoded image, wherein the encoded image comprises a salient portion;
determining a bounding region for the encoded image, wherein the bounding region is indicative of a location of the salient portion in the encoded image; and
progressively rendering a decoded version of the encoded image, wherein the progressively rendering comprises rendering a high resolution version of the bounding region, and a low resolution version of a portion outside the bounding region.

29. An article of manufacture comprising one or more computer readable media having computer-readable instructions stored thereon that, when executed by one or more processors of a computing device, cause the computing device to carry out functions that comprise:
receiving a plurality of bytes of an encoded image, wherein the encoded image comprises a salient portion;
determining a bounding region for the encoded image, wherein the bounding region is indicative of a location of the salient portion in the encoded image; and
progressively rendering a decoded version of the encoded image, wherein the progressively rendering comprises rendering a high resolution version of the bounding region, and a low resolution version of a portion outside the bounding region.
